(19) United States
(12) Patent Application Publication
(10) Pub. No.: US 2017/0364524 A1
(43) Pub. Date: Dec. 21, 2017

(54) ENRICHED LOCATION TRAIL FOR TASK COMPLETION AND MEMORY RECALL

(71) Applicant: Microsoft Technology Licensing, LLC, Redmond, WA (US)

(72) Inventors: Suryanarayana Shastri, Hyderabad (IN); Vipindeep Vangala, Hyderabad (IN); Deepinder Gill, Hyderabad (IN); Nishant Saxena, Hyderabad (IN); Snehdip Karandikar, Hyderabad (IN)

(73) Assignee: Microsoft Technology Licensing, LLC, Redmond, WA (US)

(21) Appl. No.: 15/186,790

(22) Filed: Jun. 20, 2016

(51) Int. Cl. G06F 17/30

(52) U.S. Cl. CPC G06F 17/3087

(57) ABSTRACT

In non-limiting examples of the present disclosure, systems, methods and devices for providing enriched location trail recall are presented. Location coordinates for a plurality of locations comprising a location trail may be received. The location trail may be enriched with user information and world knowledge. A request for a location-based recommendation may also be received. The request may be analyzed with a language-based model for ranking user intent and one or more constraints of the request may be evaluated. The one or more constraints may be evaluated against the enriched location trail data and a plurality of results for task completion may be filtered and ranked. The ranking may incorporate the enriched content for the location trail in categorizing the plurality of results.

### BACKGROUND

The advancement of artificial intelligence (AI) technologies has simplified and economized the way that people interact with computers. Those technologies are now nearly ubiquitous in our everyday lives. Digital personal assistants, for example, incorporate a wide range of AI technologies that perform functions that aid in planning activities, organizing events and completing everyday tasks.

It is with respect to this general technical environment that aspects of the present technology disclosed herein have been contemplated. Furthermore, although a general environment has been discussed, it should be understood that the examples described herein should not be limited to the general environment identified in the background.

### SUMMARY

This summary is provided to introduce a selection of concepts in a simplified form that are further described below in the Detailed Description section. This summary is not intended to identify key features or essential features of the claimed subject matter, nor is it intended to be used as an aid in determining the scope of the claimed subject matter.

Non-limiting examples of the present disclosure describe systems, methods and devices for providing enriched location trail recall. Location coordinates for a plurality of locations comprising a location trail may be received. A request for a location-based recommendation may also be received. The request may be analyzed with a language-based model for ranking user intent and one or more constraints of the request may be evaluated. Upon evaluating the one or more constraints a plurality of results for task completion based on the one or more constraints may be filtered and the filtered results may be ranked according to user intent based on an enriched location trail.

### BRIEF DESCRIPTION OF THE DRAWINGS

Non-limiting and non-exhaustive examples are described with reference to the following figures:

FIG. 1 is a schematic diagram illustrating an example distributed computing environment for providing enriched location trail recall.

FIG. 2 illustrates an exemplary location trail with four location data points.

FIG. 3 is a schematic diagram illustrating an example distributed computing environment for enriching data received from a first location in a location trail.

FIG. 4 is a schematic diagram illustrating an example distributed computing environment for enriching data received from a second location in a location trail.

FIG. 5 is a schematic diagram illustrating an example distributed computing environment for enriching data received from a third location in a location trail.

FIG. 6 is a schematic diagram illustrating an example distributed computing environment for enriching data received from a fourth location in a location trail.

FIG. 7 is an exemplary method for providing enriched location trail recall.

FIG. 8 illustrates a computing device for executing one or more aspects of the present disclosure.

FIG. 9 is a simplified block diagram of a computing device with which aspects of the present disclosure may be practiced.

FIG. 10 is a block diagram illustrating physical components (e.g., hardware) of a computing device 1000 with which aspects of the present disclosure may be practiced.

FIG. 11 is a schematic diagram illustrating an example distributed computing environment for providing enriched location trail recall.

### DETAILED DESCRIPTION

Various embodiments will be described in detail with reference to the drawings, wherein like reference numerals represent like parts and assemblies throughout the several views. Reference to various embodiments does not limit the scope of the claims attached hereto. Additionally, any examples set forth in this specification are not intended to be limiting and merely set forth some of the many possible embodiments for the appended claims.

The various embodiments and examples described above are provided by way of illustration only and should not be construed to limit the claims attached hereto. Those skilled in the art will readily recognize various modifications and changes that may be made without following the example embodiments and applications illustrated and described herein, and without departing from the true spirit and scope of the claims.

Generally, the present disclosure is directed to enriching location data received from one or more computing devices at one or more points in a location trail and selectively providing the enriched location data back to a device associated with a enriched location trail service. In particular, a location trail refers to a plurality of locations that a client device sends location coordinates and a timestamp from. The sent content can then be processed and enriched with additional content extracted from one or more sources. Sources from which additional content may be extracted from may include user resources such as web browsing history (natural language extraction and keyword recognition), application use and browsing history, documents created or accessed by a user, calendar information, contact lists, emails and photographs (OCR and facial recognition). Additional content may also include world knowledge including web search results and webpages, compiled user data (e.g., stored content received from a plurality of subscribers to an enriched location trail service), maps and other content related to a location in a location trail.

According to certain aspects the data extracted from the user resources and world knowledge resources may be stored and evaluated in an offline process (e.g., by a server computing device) to provide additional enriched content to a client at a later time. Alternatively and additionally the evaluation of the data extracted from the user resources and world knowledge resources may be performed in an online manner (e.g., while a user is concurrently performing actions related to a task).

According to additional aspects additional processing of received location and time data may be performed. Additional processing may include creating and storing a unique ID for each location in a location trail such that the ID for each location can be queried for data enrichment. For example, location coordinates received for a first location in a location trail may be received and the GPS coordinates evaluated against a database having venue names to determine whether a the GPS coordinates relate to a particular venue, such as AT&T Park in San Francisco. Additional processing of received location data may also include categorizing a venue that relates to a location in a location trail. Categorizing a venue may include determining what type of entity the venue most readily relates to such as restaurants, hotels, offices, sports venue, etc.

According to some aspects an enriched response to a request for a location-based recommendation may be sent to a device proactively. For example, a user may visit San Francisco in December 2016 and an enriched location trail may be created during that visit. That is, during the December 2016 visit to San Francisco location coordinates and a timestamp may be sent by one or more user devices (e.g., a smart phone, a tablet, etc.) to a enriched location trail service for data enrichment. The location and time data may be sent at various locations that the user visits during his trip. Such data may be sent to the enriched location trail service at locations such as a hotel where the user is staying, a baseball stadium where the user watches a game, restaurants the user eats at, as well as other points of interest that the user visits such as the Golden Gate Bridge, Coit Tower, etc.

According to the example above, the user may return home from his December 2016 trip to San Francisco and at some point in the future decide to plan a trip to another location such as Seattle. The user may access a hotel booking site or application on one or more of their associated computing devices, which may trigger the systems and devices described herein to proactively send hotel recommendations to the user. For example, location and time data from the 2016 San Francisco enriched location trail may include information related to the hotel that the user visited and stayed at during that trip. That data may have been enriched and a determination made that the user stayed at a four star hotel during that trip. As such, when the user views content at a later date related to hotel booking, a recommendation of four star hotels that may be of interest to the user (i.e., enriched data from the 2016 San Francisco trip) may be proactively sent to a user device.

According to additional aspects an enriched response to a request for a location-based recommendation may be sent to a device reactively. For example, a user planning a second trip to San Francisco may have enjoyed dining at certain restaurants, visiting a museum and shopping at various locations during their December 2016 trip to San Francisco. Rather than having to look through their calendars, emails and receipts to locate the names of these places, which may not be available, a user may input a query into a computing device related to that trip. Such a query may be input through tactile interaction with a device (e.g., typing the query) or through voice interaction (e.g., speaking the query). For example, the user may input a query such as:

“What restaurant did I go to when I visited San Francisco last year?”;

“What museums did I go to when I visited San Francisco last year?”;

“What toy store did I go to during my trip to San Francisco?”; and

“Where did I go when I was in San Francisco?”

According to some examples results may be filtered prior to sending a recommendation to a user. For example, in the first two examples above (i.e., “What restaurant did I go to when I visited San Francisco last year?” and “What museums did I go to when I visited San Francisco last year?”) location, venue category and time constraints may be applied to filter results prior to sending a recommendation to a user. In the first example, a location constraint may be San Francisco, a venue category constraint may be restaurants and a time constraint may be one year from the date that the example query is received or the calendar year prior to the calendar year in which the example query is received (e.g., 2015). In the second example, a location constraint may be San Francisco, a venue category may be museums and a time constraint may be one year from the date that the example query is received or the calendar year prior to the calendar year in which the example query is received.

In contrast, in the third example above (i.e., “What toy store did I go to during my trip to San Francisco?”) location and venue category constraints may be applied to filter results prior to sending a recommendation to a user. In the third example a location constraint may be San Francisco and a venue category may be stores, toy stores, or retail. In the fourth example above (i.e., “Where did I go when I was in San Francisco?”) the location constraint of San Francisco may be applied based on the query. Although the fourth example query does not contain an explicit time constraint (e.g., last year) the systems disclosed herein may automatically apply a time constraint to queries that lack an explicit constraint. For example, in order to provide relevant recommendations to a user various time constraints may be automatically applied based on criteria such as prior user query patterns (i.e., machine learning), the device used to create the query (e.g., smart phone vs. personal computer), as well as storage and processing cost criteria.

In addition to the examples above, the systems and methods described herein may also enrich received location and time data with contact information and provide a response to a query related to contacts that were at one or more locations. For example, a query may be input by a user such as “Who did I meet with when I was in San Francisco?”. In that instance, a user's contact list and calendar may be used to supplement and enrich the location and time data in generating a response to the user. For example, the location constraint of San Francisco may be applied to the query as well as a contact constraint. The contact constraint may be used to filter each location where neither calendar information nor a contact list provides an indication that the user was accompanied by a contact at such a location. Responses such as “You met with contacts A, B and C while you were in San Francisco” or “You met with contact A at AT&T Park on Day 1, You met with Contact B at Coit Tower on Day 2” may then be sent to the user.

In addition to filtering results additional processing may also include ranking the filtered results according to user intent based on an enriched location trail prior to sending a recommendation to a user. One or more criteria may be applied in ranking the filtered results. Criteria that may be applied include the time that a location was visited, the date that a location was visited, the amount of time spent at a location, determining, using a world graph, how important a visited location is to a group of subscribers to an enriched location trail service and the user's personality (e.g., did a user make a movie recommendation on a movie application or website, has a user been shopping online for an item that may be carried at a visited location, etc.).

After enriching and processing the received location and time data the systems described herein may send a response to a user. Such a response may be a recommendation of additional locations that may be of interest to a user (e.g., a digital personal assistant's recommendation for a one-day visit to San Francisco) or it may be a hierarchical response to a query (e.g., “Where did I go when I was in San Francisco?”). A hierarchical response to a query may be provided in a format that provides a daily overview of key venues that were visited such as San Francisco Day 1: venue 1, venue 2, venue 3; San Francisco Day 2: venue 1, venue 2, venue 3, etc. According to additional examples a hierarchical response to a query may categorize the response by venue type such as San Francisco Restaurants Visited; San Francisco Museums Visited, etc.

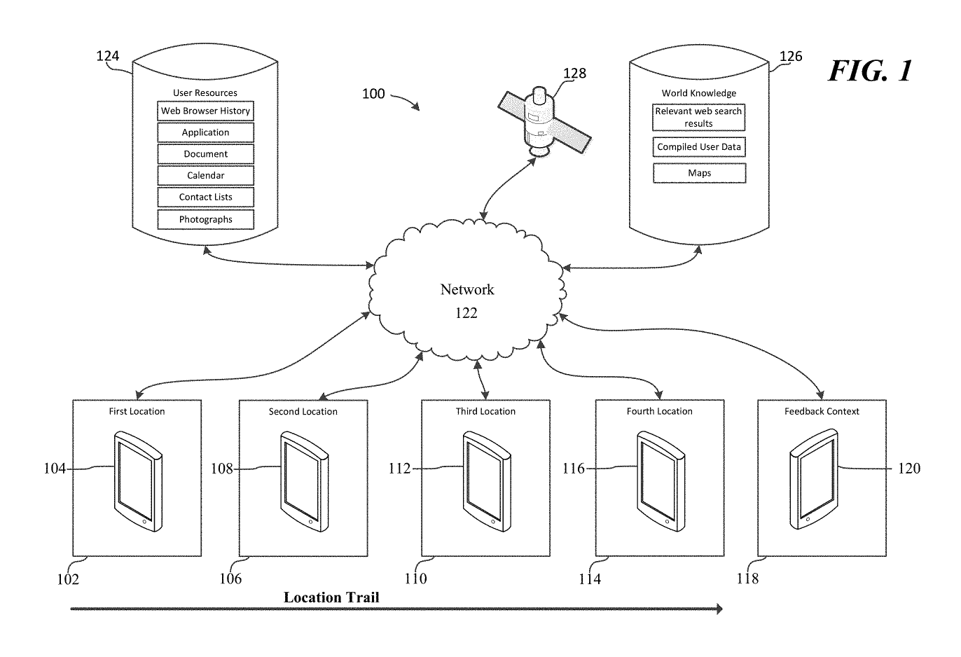

Turning to FIG. 1, a schematic diagram illustrating an example distributed computing environment 100 for providing enriched location trail recall is shown. The distributed computing environment 100 includes a location trail comprised of a first location 102, a second location 106, a third location 110 and a fourth location 114. Each of the locations 102, 106, 110 and 114 in the location trail includes a computing device 104, 108, 112 and 116 from which location coordinates for a location the device is at, as well as a time at which the device is at that location, can be sent via network 122 to one or more computing devices (e.g., server devices) for further processing and data enrichment.

Location data for each of locations 102, 106, 110 and 114 in the location trail may include GPS longitude and latitude information determined through communication of devices 104, 108, 112 and 116 with one or more satellites 128 and GPS systems via network 122. Additionally and alternatively, location data for each of locations 102, 106, 110 and 114 in the location trail may include longitude and latitude coordinates determined through cellular triangulation via devices 104, 108, 112 and 116, reverse IP address lookup, analysis of images taken at locations 102, 106, 110 and 114, as well as manual tagging of various data accessed or generated at locations 102, 106, 110 and 114.

Enrichment of the location and time data may be performed utilizing user resources 124 including web browser history, application use and browsing history, documents, calendar information, contact lists and photographs. Enrichment may also be performed utilizing world knowledge 126 including web search results relevant to a specific location and time, compiled user data such as user data from a plurality of subscribers to an enriched location trail service, and map information. Distributed computing environment 100 also includes a feedback context 118 including a computing device 120. The feedback context represents a time and location at which a user may be provided, proactively or reactively, with enriched location data.

Each of devices 104, 108, 112, 116 and 120 may be the same device or they may be different devices. For example, devices 104 and 108 may be a smart phone, devices 112 and 116 may be a tablet and device 120 may be a personal computer.

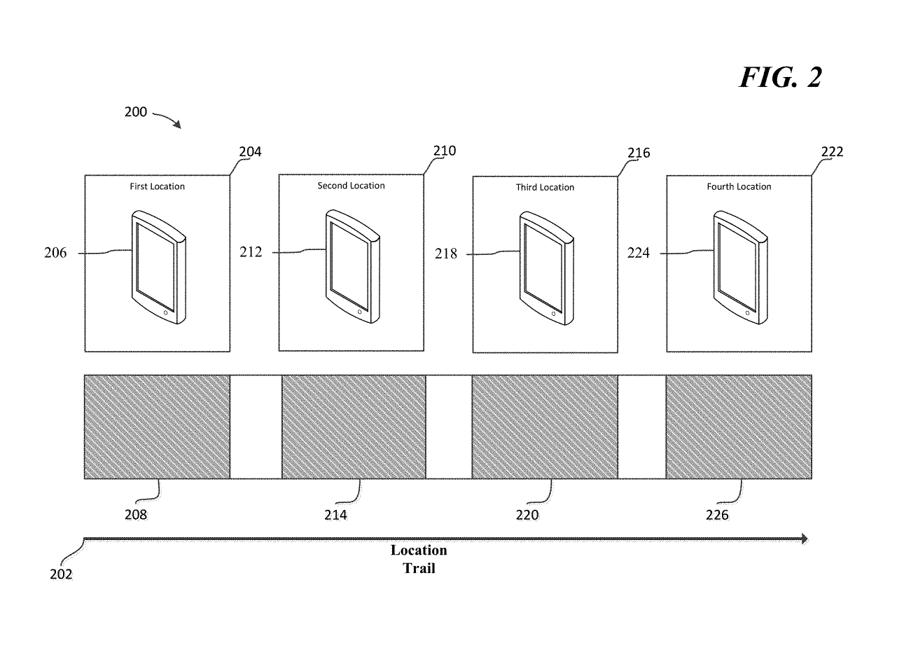

Moving to FIG. 2 an exemplary location trail system 200 having a first location 206, a second location 210, a third location 216 and a fourth location 222 in a location trail 202 is provided. Location trail 202 may represent a pattern of locations that a user visits which are recognized by the systems described herein as consisting of a unified location trail. For example, a user may spend a week in Seattle for vacation and each of the four locations in location trail 202 may represent venues that the user visited during that trip. First location 204 may represent a hotel that a user stayed at. Second location 210 may represent the Space Needle. Third location 216 may represent Pikes Place Market and fourth location 224 may represent the Seattle Art Museum.

A user may bring a mobile computing device such as a smart phone, a smart watch or a tablet with him to each of the locations in the location trail 202. Each of devices 206, 212, 218 and 224 may represent the same mobile computing device device or a different mobile computing device. For example, first device 206 may be a tablet that a user accesses while he is at his hotel. Devices 212 and 218 may be a smart watch that a user wears while he visits the Space Needle and Pikes Place Market. Device 224 may be a smart phone that a user carries with him when he is at the Seattle Art Museum.

Each of blocks 208, 214, 220 and 226 represent the sending of location and time information from a location in the location trail 202 from devices 206, 212, 218 and 224. For example, a GPS coordinates for the Westin Downtown may be sent from a tablet used to sign into an email account at block 208. At block 214 GPS coordinates for the Space Needle may be sent from a smart watch worn by a user while at that location. At block 220 GPS coordinates for Pikes Place Market may be sent from a smart watch worn by a user while at that location and at block 226 GPS coordinates for the Seattle Art Museum may be sent.

In addition to sending GPS coordinates to one or more computing devices for data enrichment and further processing, each of devices 206, 212, 218 and 224 may also send one or more timestamps while at a location. For example, at block 208 a first timestamp may be sent when a user accesses his email account from his hotel and one or more additional timestamps may also be sent at various way points while he is still logged into that account. For example, timestamps may be sent at intervals while the user is logged into his account, or a first timestamp may be sent when he first accesses his account and a second timestamp may be sent when he logs out of his account. Similarly, at blocks 214, 220 and 226 one or more timestamps may be sent from devices 212, 218 and 224 while the user as at the second location 212 (the Space Needle), the third location 218 (Pikes Place Market) and the fourth location 224 (the Seattle Art Museum).

Sending a plurality of timestamps related to a single visit to a single location may be used according to the systems and methods disclosed herein to rank and filter responses prior to sending a recommendation to a user, as well as to determine a venue corresponding to received GPS coordinates. For example, if a plurality of timestamps are sent from a single location a determination of the approximate amount of time that a user stayed at a location may be determined and a location's importance may be ranked accordingly. Similarly, determining an approximate amount of time that a user is at a location is useful in providing an indication of what a user was doing at a location for venue recognition and categorization. For example, if GPS coordinates in the general vicinity of the Seattle Art Museum are received at block 226 and timestamps also received at block 226 lead to a determination that a user was at the location related to the GPS coordinates for an hour and fifteen minutes, a movie theater nearby showing movies that are all over an hour and a half may be ruled out as the venue corresponding to the GPS coordinates.

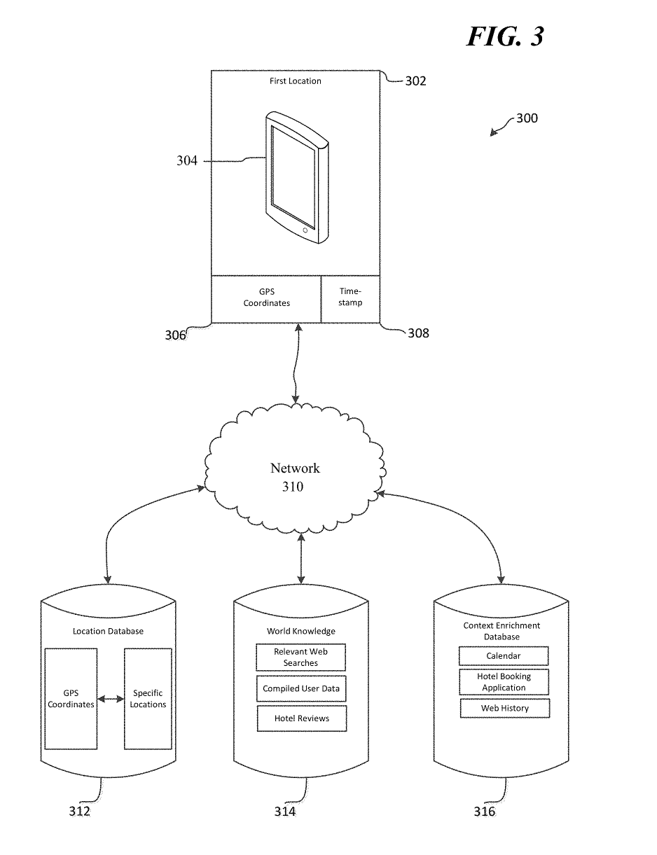

Turning to FIG. 3 a schematic diagram illustrating an example distributed computing environment 300 for enriching data received from a first location in a location trail is shown. According to this example the distributed computing environment 300 is provided to illustrate various components of the systems and methods described herein in which location coordinates and time spent at a first location 302, which in this example corresponds to a user's hotel visit, may be utilized.

Distributed computing environment 300 includes computing device 304 in a first location 302 (e.g., a hotel that a user has visited in a location trail). Computing device 304 provides GPS coordinates 306 and one or more timestamp 308 via network 310 to one or more computing devices (e.g., servers involved in an enriched location trail service) for data enrichment. The data sent from computing device 304 may be enriched and processed using a location database 312; world knowledge 314 including relevant web searches, compiled user data and hotel reviews; and context enrichment database 316 including calendar information, hotel review application information, hotel booking application information and web history, for example.

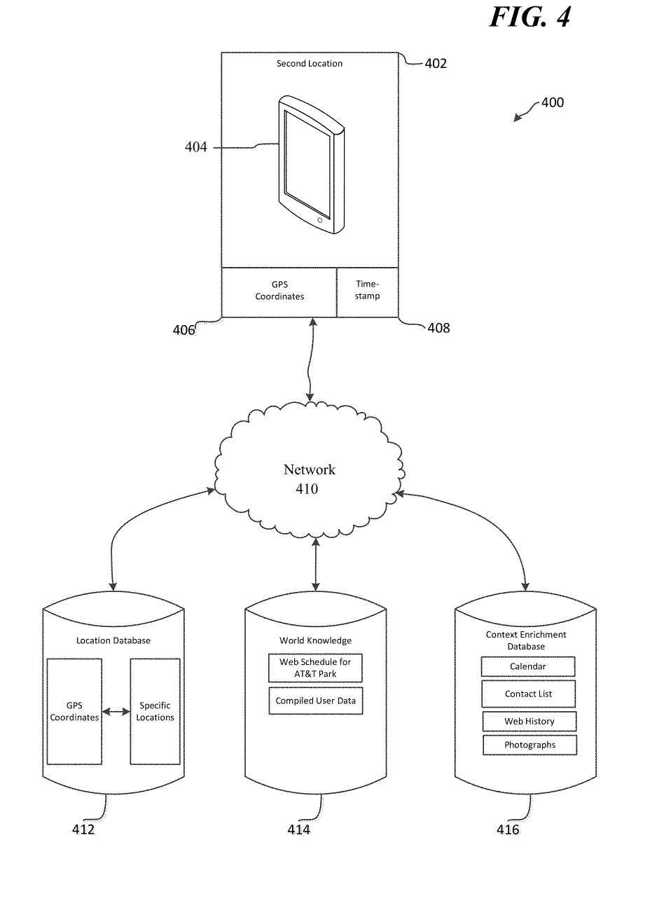

Turning to FIG. 4 a schematic diagram illustrating an example distributed computing environment 400 for enriching data received from a second location in a location trail is shown. According to this example the distributed computing environment 400 is provided to illustrate various components of the systems and methods described herein in which location coordinates and time spent at a first location 202, which in this example corresponds to a user's visit to AT&T Park to see a baseball game, may be utilized.

Distributed computing environment 400 includes computing device 404 in a second location 402 (e.g., AT&T Park). Computing device 404 provides GPS coordinates 406 and one or more timestamp 408 via network 410 to one or more computing devices (e.g., servers involved in an enriched location trail service) for data enrichment. The data sent from computing device 404 may be enriched and processed using a location database 412; world knowledge 414 including web schedule content for AT&T Park and compiled user data such as data related to second location 402 compiled from subscribers of an enriched location trail service that have also visited AT&T Park; and context enrichment database 416 including a user's calendar information, and photographs that a user has taken on device 404 at the second location 402 that may be used for content enrichment and further processing using OCR (e.g., to identify a location by analyzing results from image analysis performed during OCR and subsequent processing of those results to further determine whether text in an image may correspond to a specific venue) and image pattern recognition (e.g., to identify a specific location by pattern recognition, to identify a user's contact using facial recognition, etc.), for example.

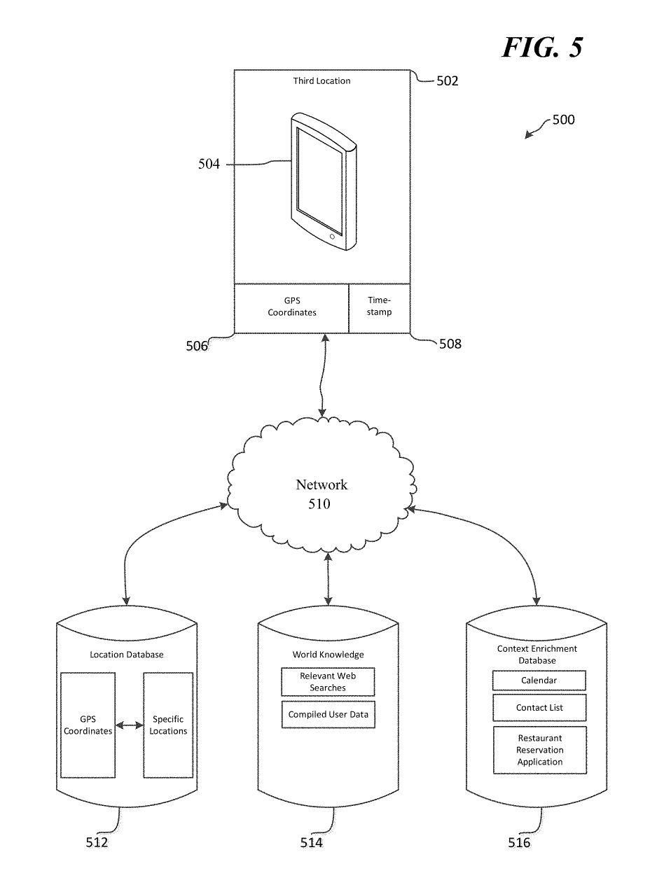

Turning to FIG. 5 a schematic diagram illustrating an example distributed computing environment 500 for enriching data received from a third location in a location trail is shown. According to this example the distributed computing environment 500 is provided to illustrate various components of the systems and methods described herein in which location coordinates and time spent at a first location 502, which in this example corresponds to a user's visit to a restaurant that a user visited.

Distributed computing environment 500 includes computing device 504 in a third location 502 (e.g., a restaurant that a user visited during a trip to San Francisco). Computing device 504 provides GPS coordinates 506 and one or more timestamp 508 via network 510 to one or more computing devices (e.g., servers involved in an enriched location trail service) for data enrichment. The data sent from computing device 504 may be enriched and processed using a location database 512; world knowledge 414 including web content related to the restaurant at location 502 that the user visited, and compiled user data such as data related to second location 502 compiled from subscribers of an enriched location trail service that have also visited the restaurant; and context enrichment database 516 including a user's calendar information, restaurant review application information, restaurant booking application information, for example.

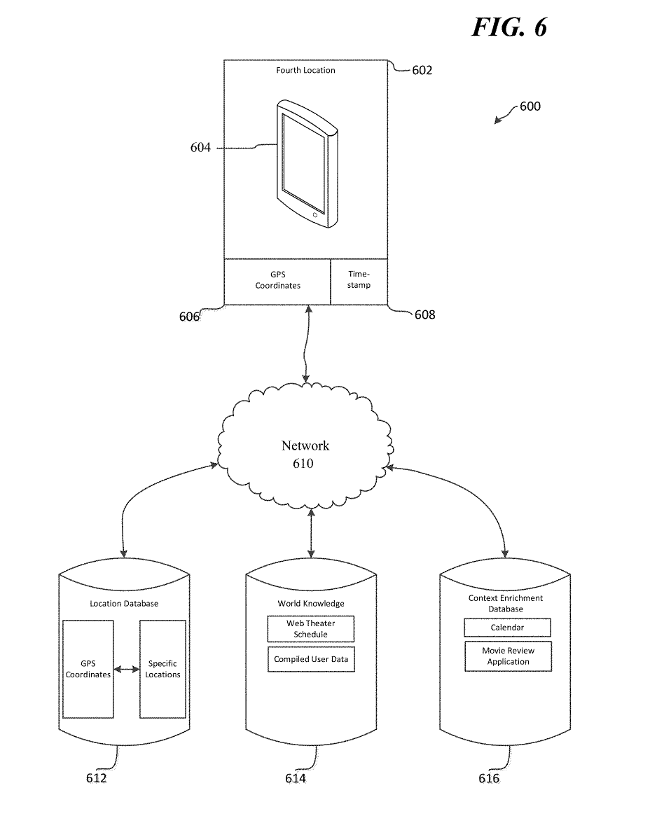

Turning to FIG. 6 a schematic diagram illustrating an example distributed computing environment 600 for enriching data received from a third location in a location trail is shown. According to this example the distributed computing environment 600 is provided to illustrate various components of the systems and methods described herein in which location coordinates and time spent at a fourth location 602, which in this example corresponds to a user's visit to a movie theater that a user visited.

Distributed computing environment 600 includes computing device 604 in a fourth location 602 (e.g., a movie theater that a user visited during a trip to San Francisco). Computing device 604 provides GPS coordinates 606 and one or more timestamp 608 via network 610 to one or more computing devices (e.g., servers involved in an enriched location trail service) for data enrichment. The data sent from computing device 604 may be enriched and processed using a location database 612; world knowledge 614 including web content related to the movie showing schedule for the theater at location 602 that the user visited, and compiled user data such as data related to fourth location 602 compiled from subscribers of an enriched location trail service that have also visited the movie theater; and context enrichment database 616 including a user's calendar information and movie review application information.

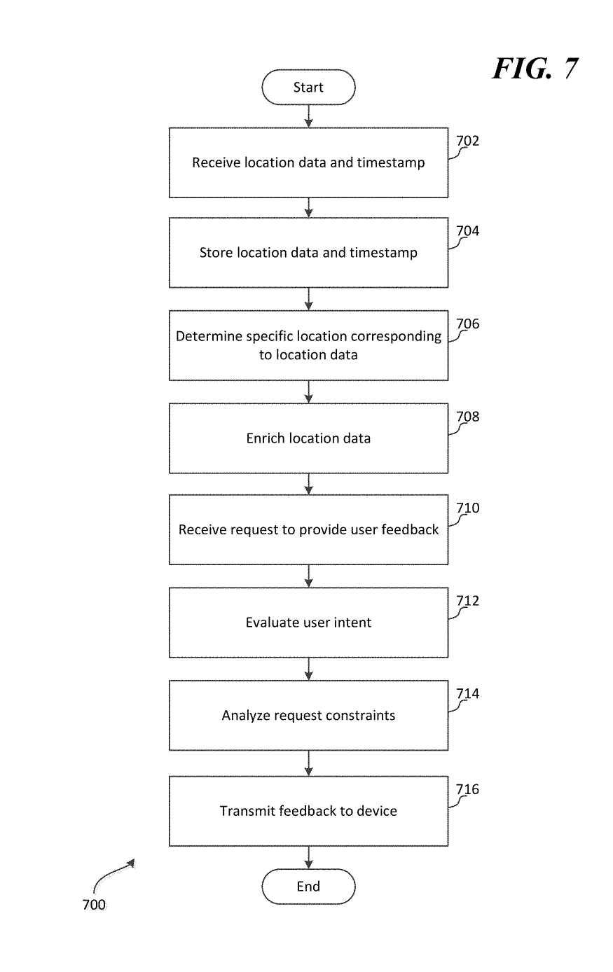

Turning to FIG. 7 an exemplary method 700 for providing enriched location trail recall is shown. The method 700 begins at operation 702 where location data and at least one timestamp are received. According to examples the location data may include GPS longitude and latitude information for a user's computing device such as a smart phone, tablet, or smart watch. According to additional examples the location data may be determined by an IP address and may include an approximate geolocation of the device having that IP address. A single timestamp may be included with the received location data (e.g., via embedded metadata) and additional timestamps for a single visit to a single location may also be received. Alternatively, a single timestamp may be received upon a device leaving a location. According to that example the single timestamp may include a total amount of time that the device was at the location or it may simply provide an indication of what time the device left the location.

According to some aspects location data and a timestamp may only be received (i.e., sent from a user's computing device) if a user's computing device has been within a radial threshold of a location for a set amount of time. For example, if it is determined that a device is moving in a single direction for a period of time the location data and timestamp may not be sent by the device.

At operation 704 the location data and the at least one timestamp are stored. Similar to the examples described above, a determination may be made whether processing storage and processing costs as well as the goals of the systems described herein warrant saving that information. That is, if a determination is made that location data and one or more timestamps were received but that such information indicates that a device has been constantly moving for a timeframe outside of a prescribed threshold, a determination may be made not to save that data.

At operation 706 a specific location, or venue (e.g., a hotel, a store, a tourist point of interest, a sports arena, etc.) is determined from the location data received at operation 704. For example, received location data (e.g., GPS coordinates) may be compared against a database comprised of specific venue names and their associated GPS coordinates. According to other examples the received location data may be compared against a database comprised of unique IDs for specific venue names and their associated GPS coordinates. A hashing system may be used, for example, to determine whether received location data corresponds to one or more specific venue.

At operation 708 the location data is enriched. Enrichment of the location data may be performed utilizing user resources such as a user's web browser history, application use and browsing history, documents accessed, calendar information, contact lists and photographs. Enrichment may also be performed utilizing world knowledge including web search results relevant to a specific location and time, compiled user data such as user data from a plurality of subscribers to an enriched location trail service, and map information. According to examples the plurality of subscribers may each have affirmatively opted in to share their information with an enriched location trail service.

At operation 710 a request is received to provide feedback to a user related to one or more locations that the user has visited. The request may be provided proactively or reactively. For example, a user may input a query to a computing device to provide enriched location trail feedback in the reactive aspect. Alternatively, proactive feedback may be provided in response to an automatically generated request when, for example, a determination is made from a user's application nor web browser history that feedback is likely to help in task completion or a recommendation may be useful to the user. Proactive feedback may also be provided in response to an automatically generated request when, for example, a determination is made that a user's device is a location during a certain time. For example, if stored location data indicates that a user had previously visited certain tourist locations in Seattle and new location and time data has been received indicating that they have returned to Seattle, a request to provide feedback such as providing the user with additional locations that they might be interested in visiting during their current visit may be received.

At operation 712 user intent related to a visited location is evaluated. According to examples a clustered intent index may be utilized in determining user intent. For example, accessed user resources may be analyzed and data from those resources extracted and further categorized into a clustered intent index. The clustered intent index may comprise a plurality of categorical hierarchies related to the extracted data. Data extracted may include the text of accessed documents (e.g., spreadsheet or other word processing document that a user has input information into), the content of websites that have been accessed, as well as optical character recognition (OCR) of images that have been accessed, by way of example. The extracted may be further processed prior to categorizing it in a clustered index. According to examples, additional processing of the extracted data may include performing natural language processing, keyword and phrase recognition, pattern recognition, etc.

Analyzing, evaluating and categorizing content from accessed resources and data extracted from accessed resources into a plurality of categorical intent hierarchies may include a multi-tiered categorization process. A determination may be made as to what resources a user has accessed while working on a task. For example, a determination may be made that a user has accessed a web search engine, one or more hotel booking websites and one or more travel booking applications in starting a hotel search task. Various metrics may then be used to rank and categorize the user's web browsing and travel application history and rank and categorize the accessed content on those resources in a plurality of categorical intent hierarchies. According to such examples, metrics that may be analyzed in relation to web browsing and application history include: the time spent on a given website or application, how deeply embedded the accessed content is in the website or application, whether the user has searched for related content on other websites or applications, whether the user has bookmarked or otherwise saved an accessed URL to a favorites list, etc.

After determining what resources a user has accessed while working on a task and evaluating metrics related to those resources an analysis related to user intent may be made. Such analysis may utilize the data extracted from accessed content and the processing of the accessed content (e.g., natural language processing) to rank and classify the data according to location-based categories (e.g., San Francisco, Seattle, Los Angeles, etc.) as well as to user intent categories (e.g., entertainment, travel, technology, literary, retail etc.). After performing first level ranking and categorization into intent categories the data may be further classified into a second tier of the intent hierarchy. For example, if it is determined in the first level ranking and categorization that the highest ranked intent category is travel, a further classification may determine what rank values should be applied to the data in sub-intent categories of travel (e.g., flight, train, car, bus, walking, etc.). Additional intent tiers may be applied according to the first intent tier classification, the analysis of the metrics to determine the rankings in the first tier and the processing of the accessed content.

According to certain aspects the data extracted from the user resources may be stored and evaluated in an offline process (e.g., by a server computing device) to enrich time and location data received from a user device (i.e., location trail enrichment). Alternatively and additionally, the evaluation of the data extracted from the user resources may be performed in an online manner (e.g., while a user is concurrently performing actions related to a task or at the time that a user inputs a query into a computing device).

Further offline and online evaluation techniques may also be applied to the extracted data to obtain content relevant to a user's task. For example, data from web pages that have been browsed, maps that have been looked at, documents that have been accessed, and applications that have been accessed may be collected at runtime and sent to one or more computing devices for further processing. The further processing may be implemented for specific extracted data that has been categorized in a hierarchical index. Alternatively and additionally, further processing may be implemented for all or a portion of extracted data that has been categorized in a hierarchical index. Such additional processing may be implemented to enrich time and location data (e.g., location trail enrichment).

The further processing of extracted data may include using results from natural language processing, keyword, phrase and pattern recognition, and OCR of images to compose search strings related to tasks and locations. The search strings may be provided to one or more of local and remote search engines. The results obtained from such queries may then be categorized and ranked according to the categorical hierarchies as described herein. According to some aspects the highest ranked results may be provided to a device and the lower ranked results may be filtered out before providing a recommendation or feedback related to a task or location.

According to additional examples queries using the results from natural language processing, keyword and phrase recognition, pattern recognition and OCR may be used to obtain content from resources specific to a user but stored on a remote storage device (e.g., the cloud). Such queries may also be used to obtain content localized to one or more user devices (e.g., via personal computer, laptop, tablet and smart phone memories) to obtain content relevant to a task, location or time. For example, local and remote documents, websites and specific web content, application content related to extracted data, user calendars and contact data (e.g., availability, meeting information, persons associated with calendar events), may be analyzed to determine whether content related to a started task, a location or a time and location should be obtained from those resources. Such a determination may include evaluating whether queries should be generated in relation to those resources and if content related to those resources and the associated analysis should be used to enrich location and time data (e.g., location trail enrichment).

Upon evaluating user intent and obtaining content from other resources that may be used for location trail enrichment, a determination of whether that content should be used for location trail enrichment. Such thresholds may be evaluated and assessed with relation to time associated data (e.g., is the additional content likely to be useful at, before or during a specific time), date (e.g., is the additional content likely to be useful at, before or on a specific date), location (e.g., is the additional content likely to be useful while a device is at, approaching or moving away from a specific location), contact information (e.g., is the additional content likely to be useful if a user contact is available or unavailable or if the user contact is present at a specific location or meeting), and event context (e.g., is the additional content likely to be useful if the event context meets a time, date, and/or locational threshold).

At operation 714 constraints related to a user provided query are analyzed. For example, the query may be analyzed to determine whether it contains time, location and contact constraints. These constraints may be used to filter possible results which may be ranked prior to sending a recommendation or other feedback to a user.

At operation 716 feedback related to the user provided query is transmitted back to a user. In order to determine what kind of feedback will be sent to a user, after filtering results according to constraints in the query, the results may be ranked according to user intent based on an enriched location trail. One or more criteria may be applied in ranking the filtered results. Criteria that may be applied include the time that a location was visited, the date that a location was visited, the amount of time spent at a location, determining, using a world graph, how important a visited location is to a group of subscribers to an enriched location trail service and the user's personality (e.g., did a user make a movie recommendation on a movie application or website, has a user been shopping online for an item that may be carried at a visited location, etc.).

According to examples, one or more of the highest ranked results may be provided back to the user as feedback. For example, if a general query such as “where did I go when I was in San Francisco last year” is received, feedback may comprise categories of places visited and a list of specific venues in each category. Alternatively, if a specific query such as “what restaurant did I eat at with Vipin when I was in San Francisco last year” is received, feedback may comprise a single venue. Other content may also be provided to a user in addition to the names of places visited. Such additional information may include photos of locations, documents or extracted information from documents and websites related to a venue, user receipts from venues, current information such as menus, pricing information, schedules from venues, contact information, etc.

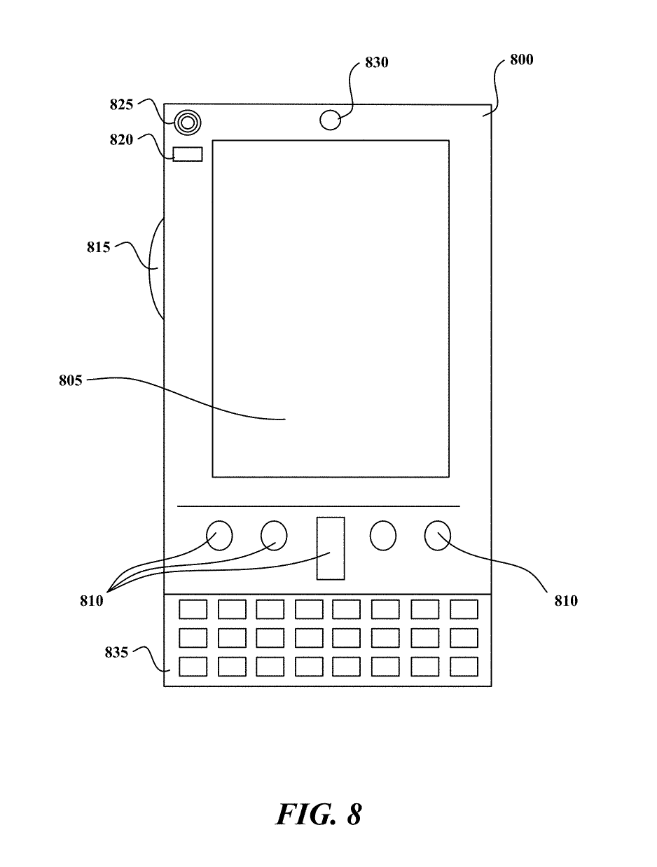

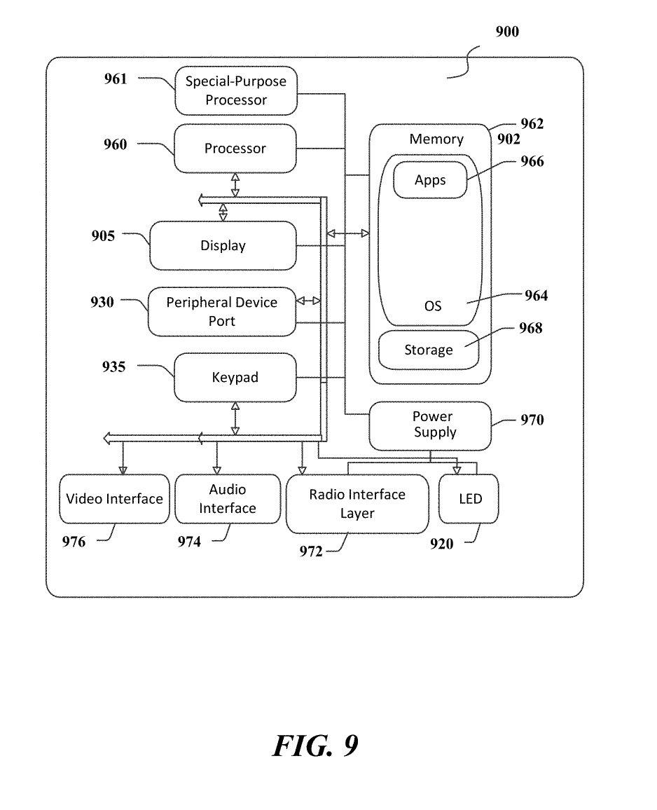

FIG. 8 and FIG. 9 illustrate computing device 800, for example, a mobile telephone, a smart phone, a tablet personal computer, a laptop computer, and the like, with which embodiments of the disclosure may be practiced. With reference to FIG. 8, an exemplary mobile computing device 800 for implementing the embodiments is illustrated. In a basic configuration, the mobile computing device 800 is a handheld computer having both input elements and output elements. The mobile computing device 800 typically includes a display 805 and one or more input buttons 810 that allow the user to enter information into the computing device 800. The display 805 of the mobile computing device 800 may also function as an input device (e.g., a touch screen display). If included, an optional side input element 815 allows further user input. The side input element 815 may be a rotary switch, a button, or any other type of manual input element.

In alternative embodiments, mobile computing device 800 may incorporate more or less input elements. For example, the display 805 may not be a touch screen in some embodiments. In yet another alternative embodiment, the mobile computing device 800 is a portable phone system, such as a cellular phone. The mobile computing device 800 may also include an optional keypad 835. Optional keypad 835 may be a physical keypad or a “soft” keypad generated on the touch screen display.

In various embodiments, the output elements include the display 805 for showing a graphical user interface (GUI), a visual indicator 820 (e.g., a light emitting diode) and/or an audio transducer 825 (e.g., a speaker). In some embodiments, the mobile computing device 800 incorporates a vibration transducer for providing the user with tactile feedback. In yet another embodiments, the mobile computing device 800 incorporates input and/or output ports, such as an audio input (e.g., a microphone jack), an audio output (e.g., a headphone jack), and a video output (e.g., a HDMI port) for sending signals to or receiving signals from an external device. In embodiments, the word processing application may be displayed on the display 805.

FIG. 9 is a block diagram illustrating the architecture of one embodiment of a mobile computing device. That is, the mobile computing device 900 can incorporate a system (i.e., an architecture) 902 to implement some aspects of the disclosure. In one aspect the system 902 is implemented as a “smart phone” capable of running one or more applications (e.g., browser, e-mail, calendaring, contact managers, messaging clients, games, and media clients/players). In some aspects, the system 902 is integrated as a computing device, such as an integrated personal digital assistant (PDA) and a wireless phone.

One or more application programs 966 may be loaded into the memory 962 and run on or in association with the operating system 964. Examples of the application programs include phone dialer programs, e-mail programs, personal information management (PIM) programs, word processing programs, spreadsheet programs, Internet browser programs, messaging programs, diagramming applications, and so forth. The system 902 also includes a non-volatile storage area 968 within the memory 962. The non-volatile storage area 968 may be used to store persistent information that should not be lost if the system 902 is powered down. The application programs 966 may use and store information in the non-volatile storage area 968, such as e-mail or other messages used by an e-mail application, and the like.

A synchronization application (not shown) also resides on the system 902 and is programmed to interact with a corresponding synchronization application resident on a host computer to keep the information stored in the non-volatile storage area 968 synchronized with corresponding information stored in the host computer. As should be appreciated, other applications may be loaded into the memory 962 and run on the mobile computing device 900, including steps and methods for providing enriched location trail recall including: transmitting location coordinates for a plurality of locations comprising a location trail and analyzing a request for a location-based recommendation.

The system 902 has a power supply 970, which may be implemented as one or more batteries. The power supply 970 might further include an external power source, such as an AC adapter or a powered docking cradle that supplements or recharges the batteries.

The system 902 may also include a radio 972 that performs the functions of transmitting and receiving radio frequency communications. The radio 972 facilitates wireless connectivity between the system 902 and the “outside world,” via a communications carrier or service provider. Transmissions to and from the radio 972 are conducted under control of the operating system 964. In other words, communications received by the radio 972 may be disseminated to the application programs 966 via the operating system 964, and vice versa. The radio 972 allows the system 902 to communicate with other computing devices such as over a network. The radio 972 is one example of communication media. Communication media may typically be embodied by computer readable instructions, data structures, program modules, or other data in a modulated data signal, such as a carrier wave or other transport mechanism, and includes any information deliver media. The term “modulated data signal” means a signal that has one or more of its characteristics set or changed in such a manner as to encode information in the signal. By way of example, not limitation, communication media includes wired media such as a wired network or direct-wired connection, and wireless media such as acoustic, RF infrared and other wireless media. The term computer readable media is used herein includes both storage media and communication media.

This embodiment of the system 902 provides notifications using the visual indicator 820 that can be used to provide visual notifications and/or an audio interface 974 producing audible notifications via the audio transducer 825. In the illustrated embodiment, the visual indicator 820 is a light emitting diode (LED) and the audio transducer 825 is a speaker. These devices may be directly coupled to the power supply 970 so that when activated, they remain on for a duration dictated by the notification mechanism even though the processor 960 and other components might shut down for conserving battery power. The LED may be programmed to remain on indefinitely until the user takes action to indicate the powered-on status of the device. The audio interface 974 is used to provide audible signals to and receive audible signals from the user. For example, in addition to being coupled to the audio transducer 825, the audio interface 974 may also be coupled to a microphone to receive audible input, such as to facilitate a telephone conversation. In accordance with embodiments of the present invention, the microphone may also serve as an audio sensor to facilitate control of notifications, as will be described below. The system 902 may further include a video interface 976 that enables an operation of an on-board camera 830 to record still images, video stream, and the like.

A mobile computing device 900 implementing the system 902 may have additional features or functionality. For example, the mobile computing device 900 may also include additional data storage devices (removable and/or non-removable) such as, magnetic disks, optical disks, or tape. Such additional storage is illustrated in FIG. 9 by the non-volatile storage area 968. Computer storage media may include volatile and nonvolatile, removable and non-removable media implemented in any method or technology for storage of information, such as computer readable instructions, data structures, program modules, or other data.

Data/information generated or captured by the mobile computing device 900 and stored via the system 902 may be stored locally on the mobile computing device 900, as described above, or the data may be stored on any number of storage media that may be accessed by the device via the radio 972 or via a wired connection between the mobile computing device 900 and a separate computing device associated with the mobile computing device 900, for example, a server computer in a distributed computing network, such as the Internet. As should be appreciated such data/information may be accessed via the mobile computing device 900 via the radio 972 or via a distributed computing network. Similarly, such data/information may be readily transferred between computing devices for storage and use according to well-known data/information transfer and storage means, including electronic mail and collaborative data/information sharing systems.

One of skill in the art will appreciate that the scale of systems such as system 902 may vary and may include more or fewer components than those described in FIG. 9. In some examples, interfacing between components of the system 902 may occur remotely, for example where components of system 902 may be spread across one or more devices of a distributed network. In examples, one or more data stores/storages or other memory are associated with system 902. For example, a component of system 902 may have one or more data storages/memories/stores associated therewith. Data associated with a component of system 902 may be stored thereon as well as processing operations/instructions executed by a component of system 902.

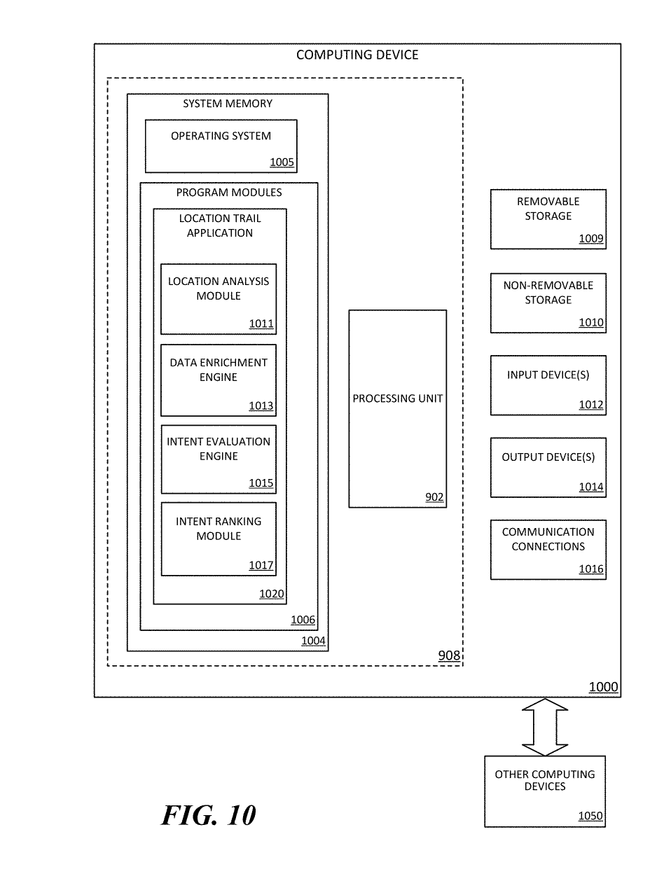

FIG. 10 is a block diagram illustrating physical components (e.g., hardware) of a computing device 1000 with which aspects of the disclosure may be practiced. The computing device components described below may have computer executable instructions for assisting with enriched location recall including receiving location coordinates for a plurality of locations comprising a location trail, receiving a request for a location-based recommendation, analyzing the request with a language-based model for ranking user intent, evaluating one or more constraints of the request, filtering a plurality of results for task completion based on the one or more constraints and ranking the filtered results according to user intent based on an enriched location trail, including computer executable instructions for location trail application 1020 that can be executed to employ the methods disclosed herein.

In a basic configuration, the computing device 1000 may include at least one processing unit 1002 and a system memory 1004. Depending on the configuration and type of computing device, the system memory 1004 may comprise, but is not limited to, volatile storage (e.g., random access memory), non-volatile storage (e.g., read-only memory), flash memory, or any combination of such memories. The system memory 1004 may include an operating system 1005 and one or more program modules 1006 suitable for location trail application 1020, such as one or more components in regards to FIG. 10 and, in particular, location analysis module 1011, data enrichment engine 1013, intent evaluation engine 1015 and intent ranking module 1017.

The operating system 1005, for example, may be suitable for controlling the operation of the computing device 1000. Furthermore, aspects of the disclosure may be practiced in conjunction with a graphics library, other operating systems, or any other application program and is not limited to any particular application or system. This basic configuration is illustrated in FIG. 10 by those components within a dashed line 1008. The computing device 1000 may have additional features or functionality. For example, the computing device 1000 may also include additional data storage devices (removable and/or non-removable) such as, for example, magnetic disks, optical disks, or tape. Such additional storage is illustrated in FIG. 10 by a removable storage device 1009 and a non-removable storage device 1010.

As stated above, a number of program modules and data files may be stored in the system memory 1004. While executing on the processing unit 1002, the program modules 1006 (e.g., location trail application 1020) may perform processes including, but not limited to, the aspects, as described herein. Other program modules that may be used in accordance with aspects of the present disclosure, and in particular may include location analysis module 1011, data enrichment engine 1013, intent evaluation engine 1015, intent ranking module 1017, etc.

Furthermore, aspects of the disclosure may be practiced in an electrical circuit comprising discrete electronic elements, packaged or integrated electronic chips containing logic gates, a circuit utilizing a microprocessor, or on a single chip containing electronic elements or microprocessors. For example, aspects of the disclosure may be practiced via a system-on-a-chip (SOC) where each or many of the components illustrated in FIG. 10 may be integrated onto a single integrated circuit. Such an SOC device may include one or more processing units, graphics units, communications units, system virtualization units and various application functionality all of which are integrated (or “burned”) onto the chip substrate as a single integrated circuit. When operating via an SOC, the functionality, described herein, with respect to the capability of client to switch protocols may be operated via application-specific logic integrated with other components of the computing device 900 on the single integrated circuit (chip). Embodiments of the disclosure may also be practiced using other technologies capable of performing logical operations such as, for example, AND, OR, and NOT, including but not limited to mechanical, optical, fluidic, and quantum technologies. In addition, embodiments of the disclosure may be practiced within a general purpose computer or in any other circuits or systems.

The computing device 1000 may also have one or more input device(s) 1012 such as a keyboard, a mouse, a pen, a sound or voice input device, a touch or swipe input device, etc. The output device(s) 1014 such as a display, speakers, a printer, etc. may also be included. The aforementioned devices are examples and others may be used. The computing device 1000 may include one or more communication connections 1016 allowing communications with other computing devices 1050. Examples of suitable communication connections 1016 include, but are not limited to, radio frequency (RF) transmitter, receiver, and/or transceiver circuitry; universal serial bus (USB), parallel, and/or serial ports.

The term computer readable media as used herein may include computer storage media. Computer storage media may include volatile and nonvolatile, removable and non-removable media implemented in any method or technology for storage of information, such as computer readable instructions, data structures, or program modules. The system memory 1004, the removable storage device 1009, and the non-removable storage device 1010 are all computer storage media examples (e.g., memory storage). Computer storage media may include RAM, ROM, electrically erasable read-only memory (EEPROM), flash memory or other memory technology, CD-ROM, digital versatile disks (DVD) or other optical storage, magnetic cassettes, magnetic tape, magnetic disk storage or other magnetic storage devices, or any other article of manufacture which can be used to store information and which can be accessed by the computing device 1000. Any such computer storage media may be part of the computing device 1000. Computer storage media does not include a carrier wave or other propagated or modulated data signal.

Communication media may be embodied by computer readable instructions, data structures, program modules, or other data in a modulated data signal, such as a carrier wave or other transport mechanism, and includes any information delivery media. The term “modulated data signal” may describe a signal that has one or more characteristics set or changed in such a manner as to encode information in the signal. By way of example, and not limitation, communication media may include wired media such as a wired network or direct-wired connection, and wireless media such as acoustic, radio frequency (RF), infrared, and other wireless media.

The different aspects described herein may be employed using software, hardware, or a combination of software and hardware to implement and perform the systems and methods disclosed herein. Although specific devices have been recited throughout the disclosure as performing specific functions, one of skill in the art will appreciate that these devices are provided for illustrative purposes, and other devices may be employed to perform the functionality disclosed herein without departing from the scope of the disclosure.

As stated above, a number of program modules and data files may be stored in the system memory 1004. While executing on processing unit 1002, program modules (e.g., applications, Input/Output (I/O) management, and other utilities) may perform processes including, but not limited to, one or more of the operational stages of the methods described herein.

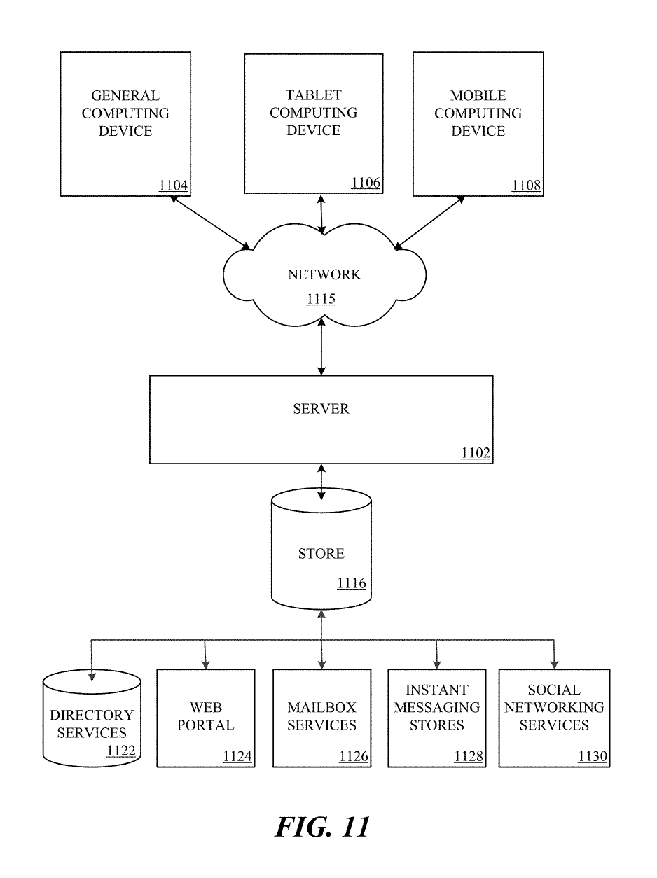

FIG. 11 illustrates one example of the architecture of a system for providing an application assists with enriched location trail recall as described above. Location and time data accessed, interacted with, or edited in association with programming modules, location trail application 1006 and storage/memory which may be stored in different communication channels or other storage types. For example, various documents may be stored using a directory service 1122, a web portal 1124, a mailbox service 1126, an instant messaging store 1128, or a social networking site 1130, application 1006, an IO manager, other utilities and storage systems may use any of these types of systems or the like for enabling data utilization, as described herein. A server 1102 may provide a storage system for use by a client operating on a general computing device 1104 and mobile computing devices 1106 through network 1115. By way of example, network 1115 may comprise the Internet or any other type of local or wide area network, and client nodes may be implemented as a computing device embodied in a personal computer, a tablet computing device 1106, and/or by a mobile computing device 1108 (e.g., mobile processing device). Any of these examples of the computing devices described herein may obtain content from the store 1116.

Reference has been made throughout this specification to “one example” or “an example,” meaning that a particular described feature, structure, or characteristic is included in at least one example. Thus, usage of such phrases may refer to more than just one example. Furthermore, the described features, structures, or characteristics may be combined in any suitable manner in one or more examples.

One skilled in the relevant art may recognize, however, that the examples may be practiced without one or more of the specific details, or with other methods, resources, materials, etc. In other instances, well known structures, resources, or operations have not been shown or described in detail merely to observe obscuring aspects of the examples.

While examples and applications have been illustrated and described, it is to be understood that the examples are not limited to the precise configuration and resources described above. Various modifications, changes, and variations apparent to those skilled in the art may be made in the arrangement, operation, and details of the methods and systems disclosed herein without departing from the scope of the claimed examples.

What is claimed is:

1. A method for providing enriched location trail recall, comprising:
receiving location coordinates for a plurality of locations comprising a location trail;
receiving a request for a location-based recommendation;
analyzing the request with a language-based model for ranking user intent;
evaluating one or more constraints of the request;
filtering a plurality of results for task completion based on the one or more constraints; and
ranking the filtered results according to user intent based on an enriched location trail.

2. The method of claim 1, further comprising evaluating results from the language-based model and user location visit patterns to rank user intent.

3. The method of claim 2, wherein evaluating user location visit patterns comprises analyzing a categorical hierarchy of locations that a user has visited and ranking the categorical hierarchy in an order from a most visited category to a least visited category.

4. The method of claim 1, further comprising determining a plurality of specific locations corresponding to the received latitude and longitude coordinates.

5. The method of claim 4, further comprising storing, in a database, a unique ID for at least one of the plurality of specific locations.

6. The method of claim 1, further comprising storing, in a database, a time and a date that a user visited each of the plurality of locations and associating world knowledge related to at least one of the plurality of stored locations with the stored time and date.

7. The method of claim 1, wherein the plurality of results are supplemented with content associated with a user's account.

8. The method of claim 7, wherein the content associated with the user's account comprises calendar data.

9. The method of claim 7, wherein the content associated with the user's account comprises application browsing history.

10. The method of claim 7, wherein the content associated with the user's account comprises web browsing history.

11. The method of claim 1, wherein the plurality of results are supplemented with stored content received from a plurality of subscribers to an enriched location trail service.

12. The method of claim 11, wherein the stored content received from the plurality of subscribers is compiled and evaluated to determine a location's importance to the plurality of subscribers.

13. The method of claim 1, wherein the request is generated in response to an indication that one or more thresholds related to proactive task completion have been met.

14. A computer-readable storage device-comprising executable instructions that, when executed by a processor, assist with enriched location trail recall, the computer-readable medium including instructions executable by the processor for:
receiving location coordinates for a plurality of locations comprising a location trail;
receiving a request for a location-based recommendation;
analyzing the request with a language-based model for ranking user intent;
evaluating one or more constraints of the request;
filtering a plurality of results for task completion based on the one or more constraints; and
ranking the filtered results according to user intent based on an enriched location trail.

15. The computer-readable storage device of claim 14, the instructions further executable by the processor to evaluate results from the language-based model and user location visit patterns to rank user intent.

16. The computer-readable storage device of claim 15, the instructions further executable by the processor to analyze a categorical hierarchy of locations that a user has visited and rank the categorical hierarchy in an order from a most visited category to a least visited category.

17. The computer-readable storage device of clam 14, the instructions further executable by the processor to store a time and a date that a user visited each of the plurality of locations.

18. The computer-readable storage device of claim 14, the instructions further executable by the processor to supplement the plurality of results with stored content received from a plurality of subscribers to an enriched location trail service.

19. The computer-readable storage device of claim 18, the instructions further executable by the processor to compile and evaluate the stored content received from the plurality of subscribers to determine a location's importance to the plurality of subscribers.

20. A system for providing enriched location trail recall, comprising:
a memory for storing executable program code; and
a processor, functionally coupled to the memory, the processor being responsive to computer-executable instructions contained in the program code and operative to:
receive location coordinates for a plurality of locations comprising a location trail;
receive a request for a location-based recommendation;
analyze the request with a language-based model for ranking user intent;
evaluate one or more constraints of the request;
filter a plurality of results for task completion based on the one or more constraints; and
rank the filtered results according to user intent based on an enriched location trail.
